(19) United States
(12) Patent Application Publication
(10) Pub. No.: US 2013/0332477 A1
(43) Pub. Date: Dec. 12, 2013

(54) RECORD CREATING SUPPORT APPARATUS AND METHOD

(71) Applicants: Kohta NAGAI, Kanagawa (JP); Hiroki OHZAKI, Kanagawa (JP)

(72) Inventors: Kohta NAGAI, Kanagawa (JP); Hiroki OHZAKI, Kanagawa (JP)

(73) Assignee: RICOH COMPANY, LTD., Tokyo (JP)

(21) Appl. No.: 13/909,207

(22) Filed: Jun. 4, 2013

(30) Foreign Application Priority Data
Jun. 12, 2012 (JP) 2012-133280

(51) Int. Cl. G06F 17/30

(52) U.S. Cl. CPC G06F 17/30684
USPC 707/758

(57) ABSTRACT

A record creating support apparatus to support creation of a record may include an extracting unit that extracts a special word from a record that is being created, a searching unit that searches a special word dictionary in order to determine whether the special word extracted by the extracting unit is registered in the special word dictionary, and a notifying unit that notifies the special word when the searching unit determines that the special word is not registered in the special word dictionary.

### CROSS-REFERENCE TO RELATED APPLICATIONS

This application is based upon and claims the benefit of priority of the Japanese Patent Application No. 2012-133280, filed on Jun. 12, 2012, the entire contents of which are incorporated herein by reference.

### BACKGROUND OF THE INVENTION

1. Field of the Invention

The present invention generally relates to a record creating support apparatus, a record creating support method, and a record creating support system.

2. Description of the Related Art

A record (or minutes) of proceedings of a conference (or meeting) or the like are desirably created as quickly as possible after the conference or the like ends, and contents of the record, including words, are desirably accurate. On the other hand, creating the record requires certain time and effort in order to make necessary improvement, editing, and the like.

Conventionally, in order to improve the efficiency of creating the record, Japanese Laid-Open Patent Publication No. 2009-069172 proposes a technique to convert speech made during the conference into character information, specify each speaker, and create the record of the character information in correspondence with each speaker.

On the other hand, word processing software such as MICROSOFT WORD ((or MS WORD), registered trademark) is provided with a spelling check function and an editing function. The spelling check function and the editing function notify a user of possibly erroneous words or phrases, when the input spelling is incorrect, the use of a particle is incorrect, a variant or fluctuation in description exists (for example, words “matrixes” and “matrices” exist, or phrases “A moves at a speed that is faster than B” and “A moves at a speed faster than B” exist), and the like.

However, although the technique proposed by Japanese Laid-Open Patent Publication No. 2009-069172 may efficiently create the record, a manual operation is required to confirm whether the character information obtained by converting the speech is correct.

In addition, according to the functions provided in the word processing software, the spelling check and the editing are based on words limited to the words listed in general English dictionaries, English-language dictionaries, and the like. For example, the spelling check function and the editing function provided in the word processing software cannot check input errors, conversion errors, and the like of technical terms, abbreviations, and the like used in special technical fields.

### SUMMARY OF THE INVENTION

Accordingly, it is a general object in one embodiment of the present invention to provide a novel and useful record creating support apparatus, record creating support method, and record creating support system, in which the problem described above may be suppressed.

Another and more specific object in one embodiment of the present invention is to provide a record creating support apparatus, a record creating support method, and a record creating support system, which may notify technical terms, abbreviations, and the like that are not listed in general English dictionaries, English-language dictionaries, and the like, to a creator of a record when the creator is creating the record, in order to enable the creator to immediately confirm whether an error exists in the record, and to correct the error if any.

According to one aspect of the present invention, a record creating support apparatus to support creation of a record may include a storage unit configured to store a program; and a processor configured to execute the program, wherein the processor includes an extracting unit configured to extract a special word from a record that is being created; a searching unit configured to search a special word dictionary in order to determine whether the special word extracted by the extracting unit is registered in the special word dictionary; and a notifying unit configured to notify the special word when the searching unit determines that the special word is not registered in the special word dictionary.

According to another aspect of the present invention, a record creating support method to support creation of a record by a computer may include extracting, by the computer, a special word from a record that is being created; searching, by the computer, a special word dictionary in order to determine whether the special word extracted by the extracting is registered in the special word dictionary; and notifying, by the computer, the special word when the searching determines that the special word is not registered in the special word dictionary.

Other objects and further features of the present invention will be apparent from the following detailed description when read in conjunction with the accompanying drawings.

### BRIEF DESCRIPTION OF THE DRAWINGS

FIG. 1 is a block diagram illustrating an example of a configuration of a record creating support system in one embodiment of the present invention;

FIG. 2 is a block diagram illustrating an example of a hardware configuration of a record creating support apparatus in one embodiment of the present invention;

FIG. 3 is a block diagram illustrating an example of a hardware configuration of a terminal apparatus in one embodiment of the present invention;

FIG. 4 is a block diagram illustrating an example of a functional configuration of the record creating support apparatus in one embodiment of the present invention;

FIG. 5 is a diagram illustrating an example of a structure of information stored in a past record storage part in one embodiment of the present invention;

FIG. 6 is a diagram illustrating an example of a structure of information stored in a special word dictionary storage part in one embodiment of the present invention;

FIG. 7 is a sequence diagram illustrating an example of procedures of a special word dictionary creating operation in one embodiment of the present invention;

FIG. 8 is a flow chart for explaining an example of procedures of a special word extracting process in one embodiment of the present invention;

FIG. 9 is a flow chart for explaining an example of procedures of a word extracting process that takes frequency of use of word into consideration in one embodiment of the present invention;

FIG. 10 is a diagram illustrating an example of procedures of a search operation to search unregistered words from a record that is being created in one embodiment of the present invention;

FIG. 11 is a diagram illustrating an example of a structure of special words extracted for each speaker from the record that is being created in one embodiment of the present invention;

FIG. 12 is a diagram illustrating an example of a user interface screen to select an unregistered special word to be registered in one embodiment of the present invention;

FIGS. 13A, 13B, 13C, and 13D are diagrams illustrating examples of structures of information in the special word dictionary storage part in one embodiment of the present invention;

FIG. 14 is a diagram illustrating an example of the user interface screen to select a dictionary to be created in a first modification of one embodiment of the present invention;

FIG. 15 is a diagram illustrating an example of the user interface screen to select the dictionary to be used in the first modification of one embodiment of the present invention;

FIG. 16 is a diagram illustrating an example of the user interface screen to select use or non-use of speaker information in the first modification of one embodiment of the present invention;

FIG. 17 is a diagram illustrating an example of procedures of the search operation to search unregistered words from the record that is being created in the first modification of one embodiment of the present invention; and

FIG. 18 is a flow chart for explaining an example of procedures of the special word extracting process in a second modification of one embodiment of the present invention.

### DESCRIPTION OF THE PREFERRED EMBODIMENTS

A description will be given of embodiments of the present invention, by referring to the drawings.

[System Configuration]

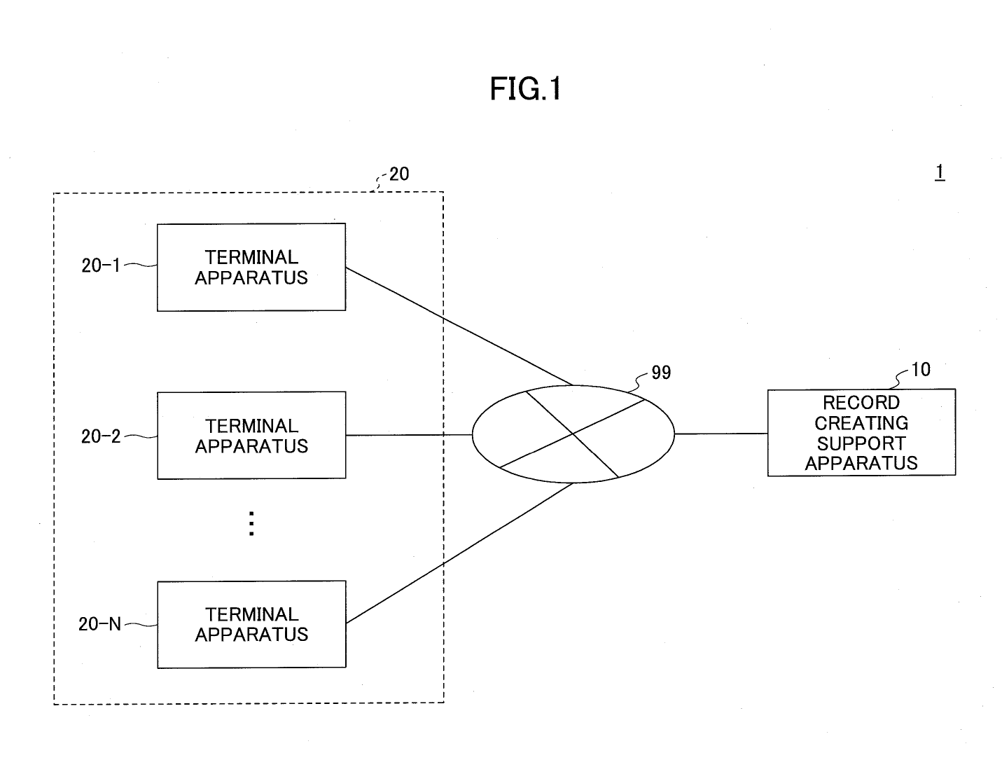

FIG. 1 is a block diagram illustrating an example of a configuration of a record creating support system 1 in an embodiment of the present invention. The record creating support system 1 illustrated in FIG. 1 may include a record creating support apparatus 10 and N terminal apparatuses 20-1, 20-2, . . . , and 20-N, where N is a natural number greater than or equal to 1. When not distinguishing each of the terminal apparatuses 20-1 through 20-N, a reference may hereinafter also be made to a “terminal apparatus 20”. The record creating support apparatus 10 and the terminal apparatus 20 are communicably connected via a network 99, such as a LAN (Local Area Network), an ETHERNET (registered trademark), and the like. The network 99 may be formed by a cable network, a wireless network, or a combination of cable and wireless networks.

The record creating support system 1 may execute an information searching process, an information store process, an information extracting process, and the like. The record creating support system 1 may operate to perform the following procedures.

A procedure (ST1) may create a special word dictionary of special words. The special words may include technical terms used in particular technical fields, words commonly used in certain organizations, abbreviations, and the like.

A procedure (ST2) may execute a search in the special word dictionary to find out whether a word included in the record that is being created is registered in the special word dictionary.

A procedure (ST3) may notify a creator of the record (hereinafter also referred to as “a record creator”) that the word searched is not registered in the special word dictionary, when the searched word is not found in the special word dictionary.

Accordingly, the record creating support system 1 may automatically notify the record creator of a word in the record that is being created, which may assumed to be an input error, a conversion error, and the like. Hence, the record creator may confirm whether the notified word is correct, and correct the word if the notified word is incorrect.

The record creating support apparatus 10 may include an information search function, an information store function, a communication function, and the like. In this embodiment, the record creating support apparatus 10 may store records that are created by the terminal apparatus 20 in the past, and the record that is being created. In addition, the record creating support apparatus 10 may extract a special word included in the past record that is stored, and create and store the special word dictionary based on the extracted word. Further, the record creating support apparatus 10 may extract a special word from the record that is being created, and execute a search in the special word dictionary in order to find out whether the extracted special word is registered in the special word dictionary.

The terminal apparatus 20 may include a document data create and/or edit function to create and/or edit document data of the record or the like, a document data inspect function to inspect the document data of the record or the like, a communication function, and the like. In this embodiment, a document data create and/or edit program (word processing software) to create electronic document data is installed in the terminal apparatus 20. The document data create and/or edit program may include the MICROSOFT WORD ((or MS WORD), registered trademark), for example. In addition, the document data may be created and/or edited using spreadsheet software and the like. The terminal apparatus 20 may be used to create a document such as the record, to inspect a record file stored in the record creating support apparatus 10, and the like. The terminal apparatus 20 may be formed by a PC (Personal Computer) or the like, for example.

[Hardware Configuration]

<Record Creating Support Apparatus>

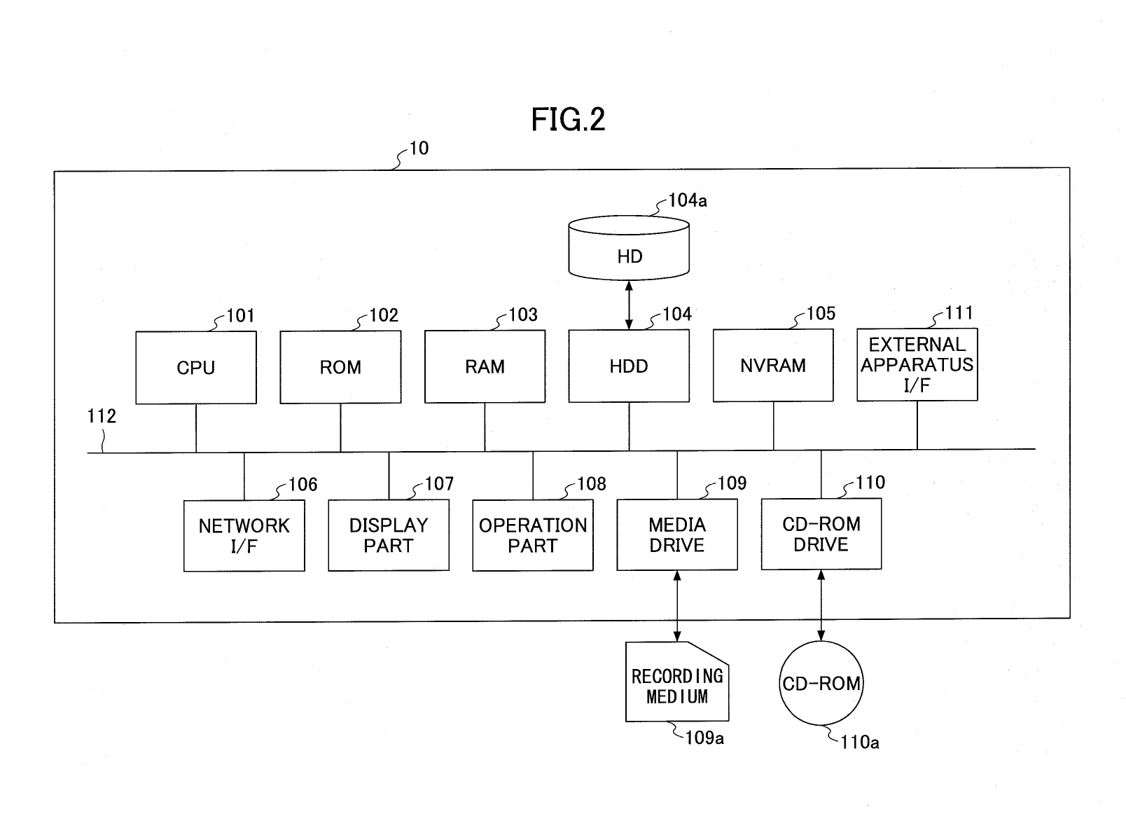

FIG. 2 is a block diagram illustrating an example of a hardware configuration of the record creating support apparatus 10 in one embodiment of the present invention. In FIG. 2, the record creating support apparatus 10 may include a CPU (Central Processing Unit) 101, a ROM (Read Only Memory) 102, a RAM (Random Access Memory) 103, an HDD (Hard Disk Drive) 104, an NVRAM (Non-Volatile Random Access Memory) 105, a network interface (I/F) 106, a display part 107, an operation part 108, a media drive 109, a CD-ROM (Compact Disk-Read Only Memory) drive 110, an external apparatus interface (I/F) 111, a bus line 112, and the like.

For example, the ROM 102 may store programs including a record creating support program of the record creating support apparatus 10, data used by the programs, and the like. The RAM 103 may provide a storage region to load the programs, a work region for the loaded programs, and the like. The CPU 101 is an example of a processor that may execute the programs of the record creating support apparatus 10, loaded into the RAM 103, in order to realize (or implement) various functions. The HDD 104 may read and write data with respect to a HD (Hard Disk) 104a, and form a storage unit to store various data. The NVRAM 105 may store various setting information of the record creating support apparatus 10 and the like.

The network I/F 106 may form a hardware to connect the record creating support apparatus 10 to the network 99 such as the LAN.

The display part 107 may provide a user interface screen with respect to the user, in order to display and output a cursor, a menu, a window, and various information such as characters, images, and the like. The user interface screen may be formed by a liquid crystal display, an organic EL (Electro-Luminescence) display, and the like.

The operation part 108 may provide hard keys and/or soft keys to be operated by the user in order to input settings, commands, and the like. The operation part 108 may provide buttons, a mouse, and the like. Further, the operation part 108 may be formed by a touchscreen panel or the like. Contents of the input made from the operation part 108 by the operation of the user may be notified to the CPU 101.

The touchscreen panel may integrally include the display part 107 and the operation part 108.

The media drive 109 may control read and write of data with respect to a recording medium 109a. The recording medium 109a may be formed by a flash memory or the like.

The CD-ROM drive 110 may be detachably loaded with a CD-ROM 110a, and control read and write of data with respect to the CD-ROM 110a. The CD-ROM 110a is an example of a detachable recording medium.

The external I/F 111 may exchange (that is, transmit and receive) information with an external apparatus.

The bus line 112 may include an address bus, a data bus, and the like in order to electrically connect the constituent elements of the record creating support apparatus 10 illustrated in FIG. 2.

The programs may be stored in a non-transitory computer-readable storage medium (or carrier medium), such as the recording medium 109a, the CD-ROM 110a, and the like, and may be loaded into the ROM 103, for example. The programs may be stored or loaded in file of an installable format or an executable format.

<Terminal Apparatus>

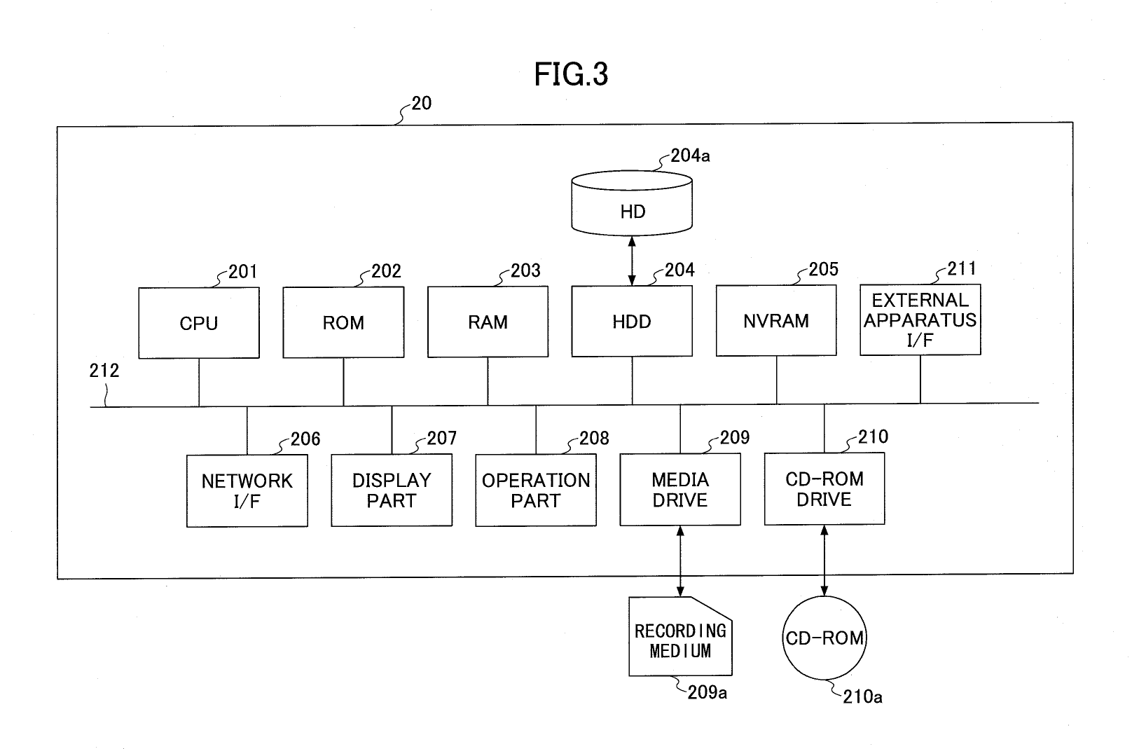

FIG. 3 is a block diagram illustrating an example of a hardware configuration of the terminal apparatus 20 in one embodiment of the present invention. In FIG. 3, the terminal apparatus 20 may include a CPU 201, a ROM 202, a RAM 203, an HDD 204, an NVRAM 205, a network I/F 206, a display part 207, an operation part 208, a media drive 209, a DC-ROM drive 210, an external apparatus I/F 211, a bus line 212, and the like.

For example, the ROM 202 may store various programs of the terminal apparatus 20, including a document data create and/or edit program, data used by the programs, and the like. The CPU 201 is an example of a processor that may execute the program of the terminal apparatus 20, loaded into the RAM 203, in order to realize various functions.

The HDD 204, the NVRAM 205, the network I/F 206, the display part 207, the operation part 208, the media drive 209, the CD-ROM drive 210, the external apparatus I/F 211, and the bus line 212 may correspond to and operate similarly to the HDD 104, the NVRAM 105, the network I/F 106, the display part 107, the operation part 108, the media drive 109, the CD-ROM drive 110, the external apparatus I/F 111, and the bus line 112, respectively, and a description thereof will be omitted.

<General Operation of Hardware>

In this embodiment, the hardware may operate to perform the following procedures.

A procedure (ST11) may store a record file of a record created in the past (hereinafter also referred to as “a past record”) in a specific folder within the HD 104a or a memory of the record creating support apparatus 10. The record file may be created and stored in the MS WORD (registered trademark) format, for example.

A procedure (ST12) may extract a special word included in the past record stored in the HD 104a, based on an instruction from a special word dictionary creating program that is started at a preset time, and temporarily stores the extracted special word in the RAM 103 or the NVRAM 105 or the like. The CPU 101 may store the special word stored in the RAM 103 or the NVRAM 105 or the like, into a special folder in the HD 104a as the special word dictionary in which a large number of special words are listed and arranged. Unlike a general (or ordinary) dictionary, the special word dictionary does not necessarily need to include information related to the meaning of each word, the usage of each word, the contents indicated by each word, and the like. The special words may exclude the words listed in general English dictionaries, English-language dictionaries, and the like.

The special word dictionary may be created by the procedures (ST11) and (ST12) described above.

A procedure (ST13) may start the word processing software, such as the MS WORD (registered trademark), that creates the record. More particularly, the user (or record creator) of the terminal apparatus 20 may use the keyboard, the mouse, or the like of the operation part 208, in order to start the word processing software that creates the record. When input contents from the operation part 108 are notified to the CPU 101, the CPU 101 may start the MS WORD (registered trademark) that is installed in advance in the HD 104a, the memory, or the like. The record creator may operate the keyboard or the like of the operation part 108, and create the record using the MS WORD (registered trademark).

A procedure (ST14) may store, by an operation of the user (or record creator), a record file of a record that is being created (hereinafter also referred to as “a creating record”) in the record creating support apparatus 10. A specific folder within the HD 104a, the memory, or the like of the record creating support apparatus 10 may be specified as a storage destination of the creating record. A data transfer from the terminal apparatus 20 to the record creating support apparatus 10 may be made using the FTP (File Transfer Protocol) or the like.

When the creating record is stored in the HD 104a of the record creating support apparatus 104a, a procedure (ST15) may extract, by the CPU 101, the special word included in the creating record, and temporarily store the extracted special word in the NVRAM 105. The timing at which the special word included in the creating record is extracted is not limited to the time when the record file is stored. For example, a button (or soft key) to be pushed when executing the special word extracting process of the record creating support program may be provided, and the special word included in the creating record may be extracted at a timing when this button is pushed. Next, the CPU 101 performs a search to determine whether the special word extracted from the creating record is registered in the special word dictionary stored in the HD 104a. When it is determined that the special word extracted from the creating record is not registered in the special word dictionary as a result of this search, the CPU 101 may temporarily store the unregistered special word (hereinafter also referred to as the “unregistered word”) in the RAM 103 or the NVRAM 105 or the like.

A procedure (ST16) may notify, by the CPU 101, the unregistered word to the terminal apparatus 20. In this embodiment, the edit function of the MS WORD (registered trademark) may be used to notify the terminal apparatus 20 of the unregistered word. In the creating record, the unregistered word may be underlined, characters of the unregistered word may be changed to a color different from the color of other characters, and the like, for example.

The confirmation on whether the special word included in the creating record is registered in the special word dictionary, and the notification of the unregistered word to the record creator, may be made by the procedures (ST13) through (ST16) described above.

[Functional Configuration]

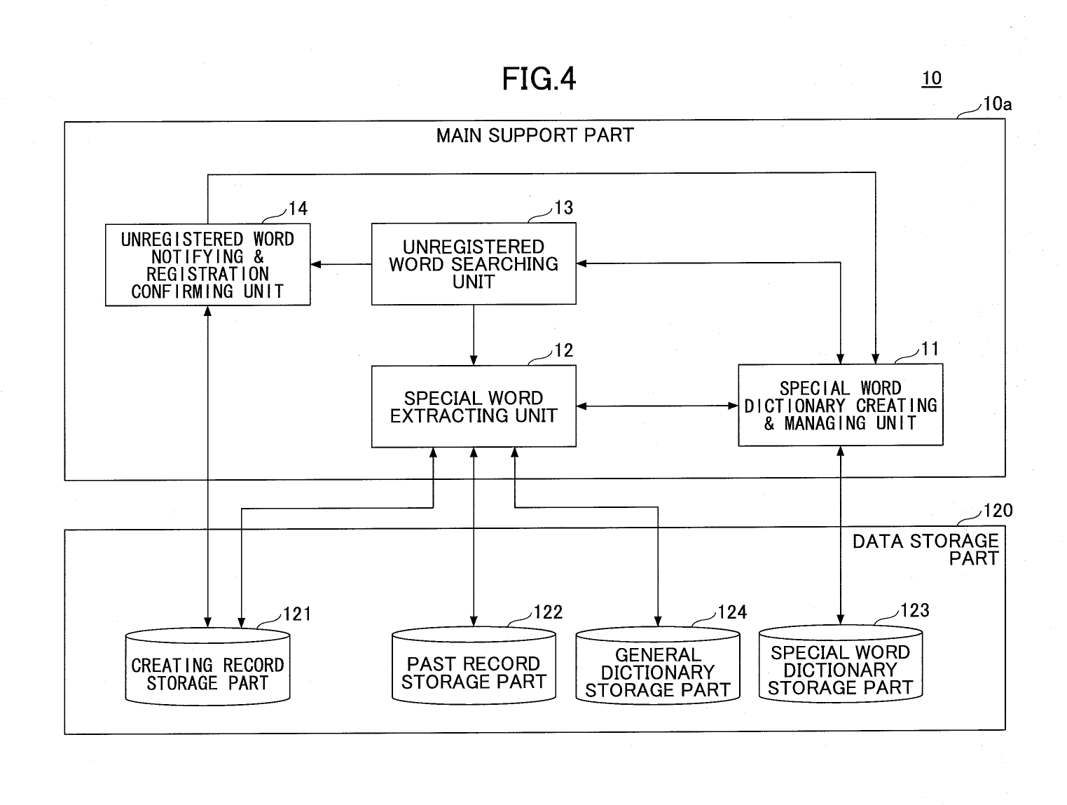

FIG. 4 is a block diagram illustrating an example of a functional configuration of the record creating support apparatus 10 in one embodiment of the present invention. Each function of the record creating support apparatus 10 may be realized in cooperation with the hardware, when the CPU 101 executes the program.

In FIG. 4, the record creating support apparatus 10 may include a main support part 10a, a data storage part 120, and the like.

The data storage part 120 may include a creating record storage part 121, a past record storage part 122, a special word dictionary storage part 123, a general dictionary storage part 124, and the like. For example, the data storage part 120 may be formed by any one or a combination of the ROM 102, the RAM 103, the HDD 104, and the NVRAM 105 illustrated in FIG. 2.

The creating record storage part 121 may store the record file created by the record creator who is the user of the terminal apparatus 20, using the MS WORD (registered trademark), for example. A search may be performed to determine whether the special word within the record file stored in the creating record storage part 121 is registered in the special word dictionary.

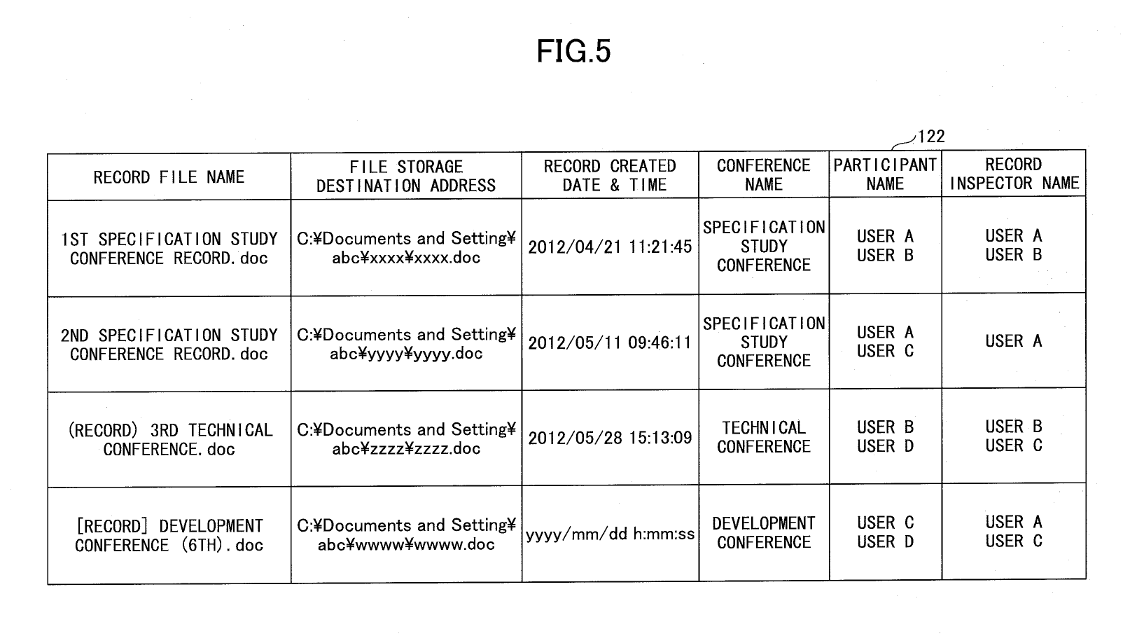

FIG. 5 is a diagram illustrating an example of a structure of information stored in the past record storage part 122 in one embodiment of the present invention. The past record storage part 122 may store information including a “record file name” indicating a name of the record file, a “file storage destination address” indicating a storage destination within the past record storage part 122, a “record creation date and time” indicating the date and time when the record is created, a “conference name” indicating a name or type of conference corresponding to the record, a “participant name” indicating a participant who participated in the conference recorded in the record, and a “record inspector name” indicating a log of users who accessed and inspected the record file stored in the past record storage part 122. The “participant name” and the “record inspector name” may be names, or IDs identifying individuals.

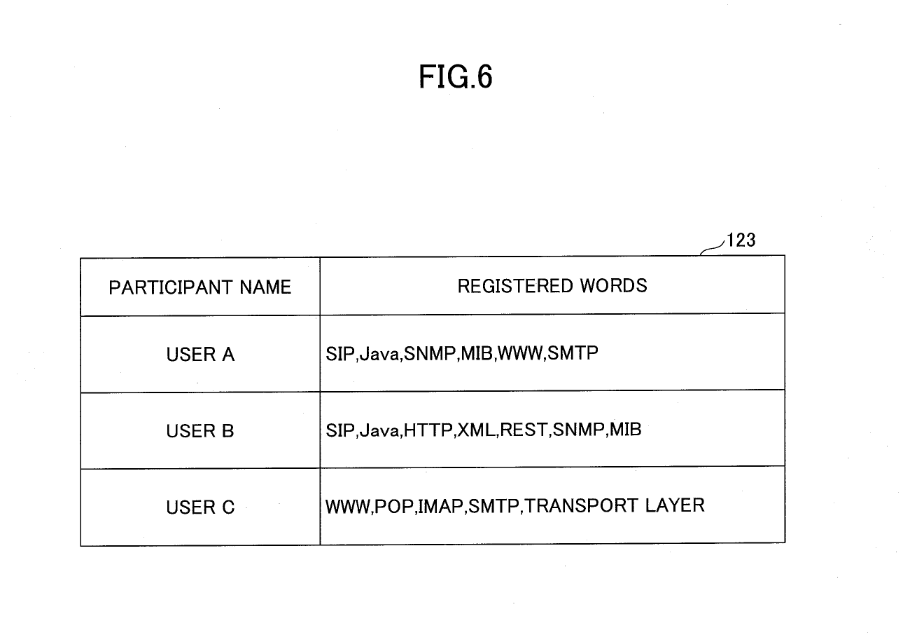

FIG. 6 is a diagram illustrating an example of a structure of information stored in the special word dictionary storage part 123 in one embodiment of the present invention. In this embodiment, the special word dictionary storage part 123 may store, in a “registered word” column, the special words included in the past record corresponding to the conference to which each participant listed under the “participant name” stored in the past record storage part 122 participated.

The general dictionary storage part 124 may store an electronic dictionary (hereinafter also referred to as a “general dictionary”) that stores electronic data of a generally used English dictionary, English-language dictionary, or the like. The general dictionary may be an electronic dictionary that is available on the market, for example. However, the general dictionary does not need to include information related to the meaning of each word, the usage of each word, the contents indicated by each word, and the like.

The main support part 10a may include a special word dictionary creating and managing unit (or means) 11, a special word extracting unit (or means) 12, an unregistered word searching unit (or means) 13, an unregistered word notifying and registration confirming unit (or means) 14, and the like.

The special word dictionary creating and managing unit 11 may create the special word dictionary based on the special words included in the past record, in response to a special word dictionary create instruction from the special word dictionary creating program that is periodically started according to a preset time schedule. More particularly, the special word dictionary creating and managing unit 11 may issue a request to extract the special word included in the past record to the special word extracting unit 12, when the special word dictionary create instruction is accepted. A response to this request from the special word dictionary creating and managing unit 11 may include the special word and identification information (for example, participant name of participant who participated in the conference) identifying the participant name. The special word dictionary may be created based on the special word and the participant name. In addition, the special word dictionary creating and managing unit 11 may execute a search in the special word dictionary in order to determine whether the special word included in the record that is being created is registered in the special word dictionary, when a request from the unregistered word searching unit 13 to detect unregistered words is accepted.

The special word extracting unit 12 may extract the special word included in the record that is being created or the past record, based on a predetermined reference. Based on a request to search the special word from the special word dictionary creating and managing unit 11 for creating the special word dictionary, the special word extracting unit 12 may extract the special word from the past record stored in the past record storage part 122. In addition, The special word extracting unit 12 may extract the special word from the record that is being created and is stored in the creating record storage part 121, in response to a process of storing the record that is being created. The special word extracting unit 12 notifies the unregistered word searching unit 13 of the special word extracted from the record that is being created.

The unregistered word searching unit 13 may execute a search in the special word dictionary in order to determine whether the special word included in the record that is being created is registered in the special word dictionary. When the request from the special word extracting unit 12 to search the unregistered word is accepted, the unregistered word searching unit 13 may notify the request to search the unregistered word to the special word dictionary creating and managing unit 11. Next, when a search result from the special word dictionary creating and managing unit 11 specifying an unregistered word list is accepted, the unregistered word searching unit 13 may notify the unregistered word notifying and registration confirming unit 14 of a request to notify the unregistered word for notifying the search result to the record creator.

When the request from the unregistered word searching unit 13 to notify the unregistered word is accepted, the unregistered word notifying and registration confirming unit 14 may edit the special words within the record that is being created, based on the unregistered word list included in this request, in order to underline the corresponding special word, for example. In addition, the unregistered word notifying and registration confirming unit 14 may generate a user interface screen for inquiring the record creator whether the unregistered word is to be newly registered in the special word dictionary.

The record creating support system 1 may perform the following processes as described above.

A process (A) may create the special word dictionary by steps (ST11 and ST12). A process (B) may search the unregistered word within the record that is being created, and notify the record creator of the search result by steps ST13 through ST16.

[Process (A) to Create Special Word Dictionary]

[Procedures of Operation]

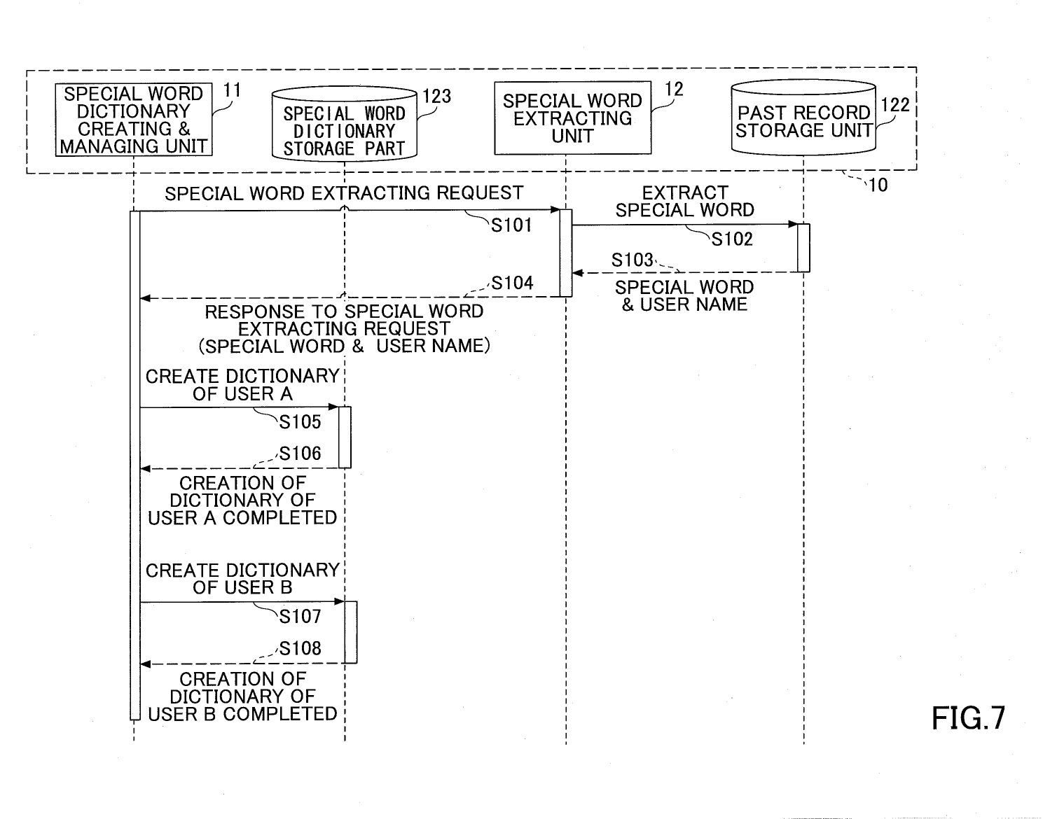

FIG. 7 is a sequence diagram illustrating an example of procedures of a special word dictionary creating operation in one embodiment of the present invention. In this embodiment, the special word dictionary may be created for each participant name of the participant who participated in the conference as illustrated in FIG. 6.

The special word dictionary may be created in response to an instruction from a special word dictionary creating program that is started at a preset time (for example, 0:00 midnight). By setting the program start time of this special word dictionary creating program to a time at night (or midnight) when the processing load on the CPU 101 and the like may be small, a sufficient required time may be secured for the creation of the dictionary from a large amount of record files, and also reduce effects on other processes. The program start time may be specified by a task scheduler provided in a WINDOWS (registered trademark) OS (Operating System), a crontab command of a LINUX (registered trademark) OS, and the like.

In step S101 in FIG. 7, the special word dictionary creating and managing unit 11 may notify the special word extracting unit 12 of a special word extracting request for extracting the special word included in the past record, based on an instruction from the special word dictionary creating program that is started at a specified time.

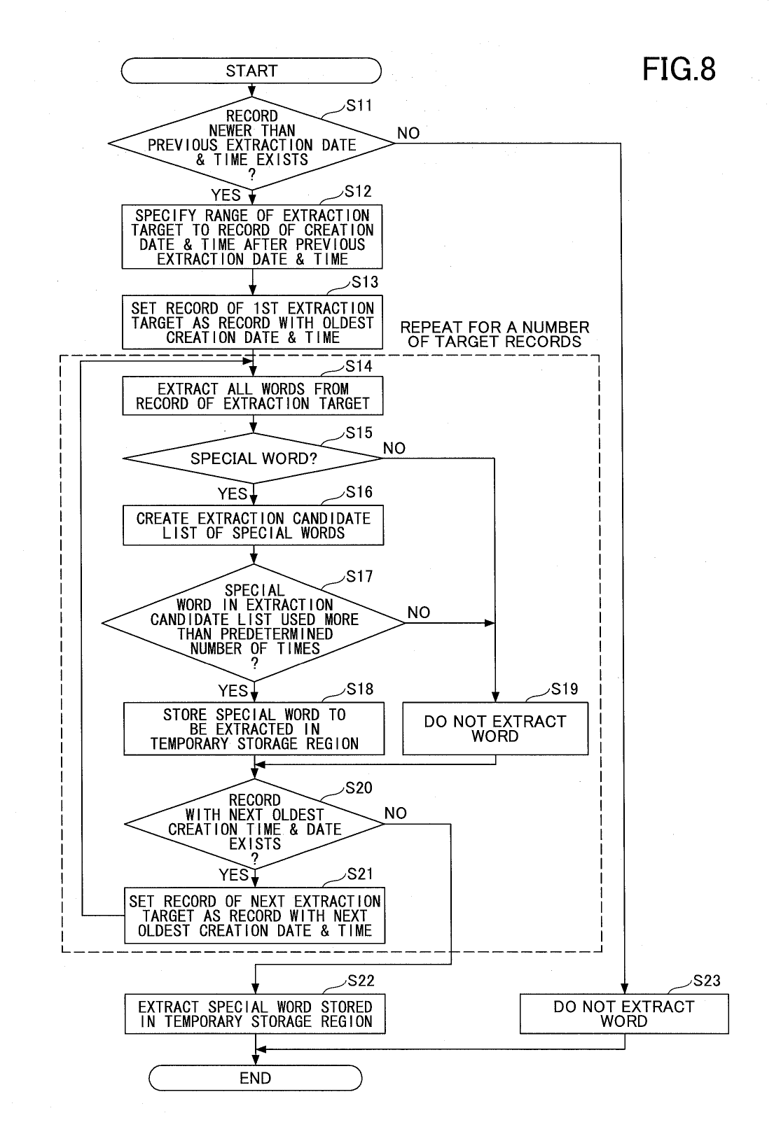

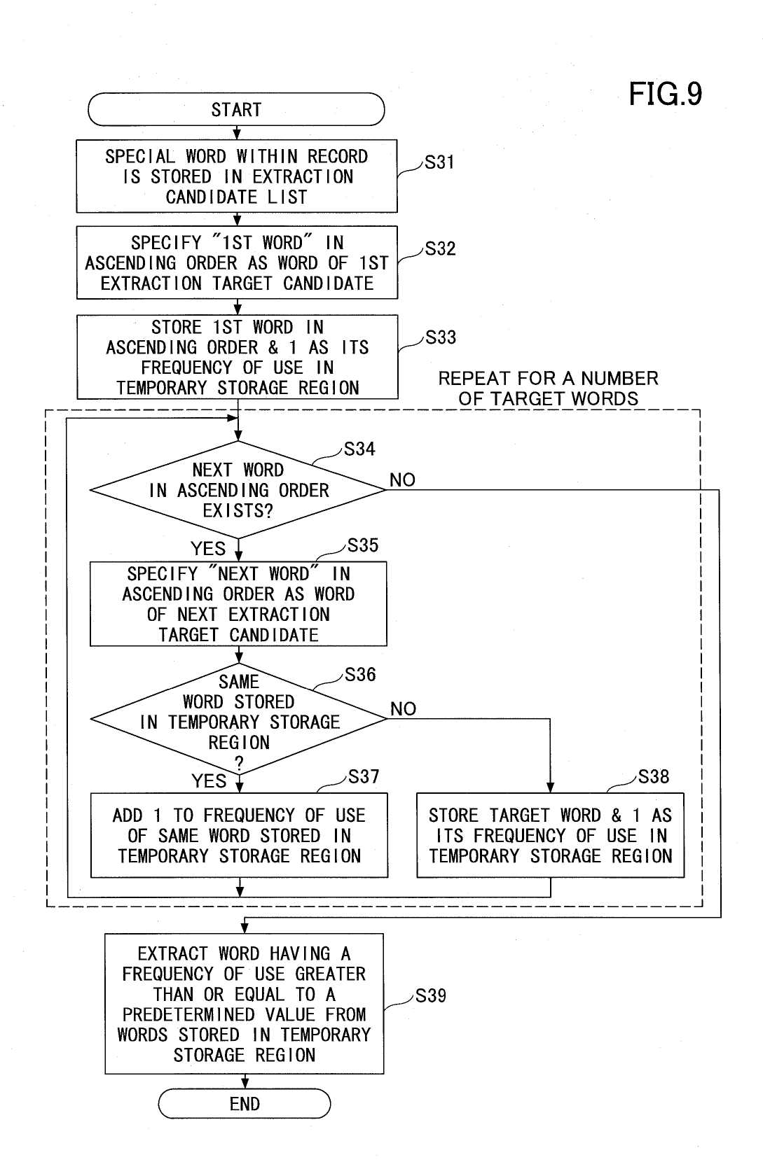

In step S102, when the special word extracting unit 12 accepts the special word extracting request, the special word extracting unit 12 may extract the participant name (or user name) stored in the past record storage part 122 and the special word included in the past record corresponding to this participant name. In other words, in a case in which a certain user participates in a plurality of conferences, the records of the plurality of conferences may be specified as extracting targets from which the special word is to be extracted. In addition, in this embodiment, only the special word having a frequency of use greater than a predetermined value may be extracted. The frequency of use of the special word may refer to the number of times this special word appears in (that is, written in) the record. By taking into consideration the frequency of use of the special word when extracting the special word, it may be possible to exclude extraction of a word that is erroneously written in the record. Details of procedures of a special word extracting process will be described later in conjunction with FIGS. 8 and 9.

In step S103, the special word extracting unit 12 may acquire the user name and the special word corresponding to the user name from the past record storage part 122, for each user name.

In step S104, the special word extracting unit 12 may notify the special word dictionary creating and managing unit 11 of a response to the special word extracting request including the special word corresponding to each user name.

In step S105, when the special word dictionary creating and managing unit 11 acquires the special word corresponding to each user name, the special word dictionary creating and managing unit 11 may create the special word dictionary for each user. When information of a plurality of users is acquired, the special word dictionary creating and managing unit 11 first creates a dictionary of a user A. The special word dictionary creating and managing unit 11 may set the “participant name” column of the special word dictionary to the user A, and the “registered word” column to the acquired special word, and store the set information in the special word dictionary storage part 123.

In step S106, the special word dictionary creating and managing unit 11 may complete creating the special word dictionary of the user A.

In step S107, the special word dictionary creating and managing unit 11 may execute a process similar to step S105, with respect to a user B.

In step S108, the special word dictionary creating and managing unit 11 may complete creating the special word dictionary of the user B.

Thereafter, the special word dictionary creating and managing unit 11 executes a dictionary creating process (steps S105 and S106) for the number of users acquired in step S104.

[Procedures of Special Word Extracting Process]

FIG. 8 is a flow chart for explaining an example of procedures of a special word extracting process in which the special word extracting unit 12 in one embodiment of the present invention extracts the special word included in the past record.

First, the special word extracting unit 12 may judge whether the record creation date and time stored in the past record storage part 122 is newer than the date and time of the previously executed special word extracting process (step S11). In a case in which a past record having the creation date and time newer than the date and time of the previously executed special word extracting process does not exist (NO in step S11), the process may end without extracting a word from the record (step S23). On the other hand, in a case in which a past record having the creation date and time newer than the date and time of the previously executed special word extracting process exists (YES in step S11), a range of the extracting target of the special word may be set to the past record having the creation date and time on or after the date and time of the previously executed special word extracting word (step S12). In the case in which the date and time of the previously executed special word extracting process does not exist in step S11, that is, in the case in which the special word dictionary is being created for the first time, all of the records stored in the past record storage part 122 may be specified as the extracting target in step S12.

Next, the record having the oldest creation date and time may be set as the record from which the word extraction is to be first performed (step S13). The method of selecting the record from which the word extraction is to be first performed is not limited to the method using the creation date and time in the ascending order, and any suitable method that does not select the same file a plurality of times from the plurality of record files, such as a method using the creation date and time in the descending order. Then, all of the words may be extracted from the past record that is set as the word extracting target (step S14). All of the words that are extracted may include the special words and the generally used words. The word extracting process may be executed using a pattern matching process of a regular expression, such as a Perl pattern matching or the like, in order to extract the word from text data included in the past record. A judgement may determine whether the word extracted in step S14 is a special word (step S15). This judgement to determine whether the extracted word is a special word may be performed by judging whether the extracted word is included in the general dictionary stored in the general dictionary storage part 124. In other words, in a case in which the extracted word is not included in the general dictionary, this extracted word may be regarded as being a special word. In a case in which the extracted word is the special word (YES in step S15), an extraction candidate list formed by the special words may be created (step S16).

Next, a judgement may be to determine whether the special word listed in the extraction candidate list is used more than a predetermined number of times (step S17). Details of the procedures of the process performed in step S17 will be described later in conjunction with FIG. 9. In a case in which the special word is used more than the predetermined number of times (YES in step S17), the special word extracted from the record may be stored in a temporary storage region of the RAM 103 or the NVRAM 105 or the like (step S18). On the other hand, in a case in which the special word is not used more than the predetermined number of times (NO in step S17), or in a case in which the word is not a special word (NO in step S15), the word is not extracted (step S19). Thereafter, after the process of step S18 or S19 ends, a judgement may be made to determine whether a record having a next oldest creation date and time exists amongst the records having the creation date and time newer than the date and time of the previous extracting process (step S20). In a case in which the record having the next oldest creation date and time exists (YES in step S20), the record having this next oldest creation date and time may be set as the record that is the word extracting target from which the word is to be extracted (step S21).

Next, the processes of steps S14 through S20 may be repeated for the number of records that are the word extracting target. In a case in which the record having the next oldest creation date and time does not exist in the past record storage part 122 (NO in step S20), the special word already stored in the temporary storage region may be extracted (step S22).

[Procedures of Word Extracting Process Taking Frequency of Use into Consideration]

FIG. 9 is a flow chart for explaining an example of procedures of a word extracting process that takes frequency of use of word into consideration in one embodiment of the present invention. The frequency of use of the word may refer to the number of times this word appears in (that is, written in) the record. For example, in a case in which a word “HTTP” appears in the record two times, the frequency of use of this word “HTTP” is “2”. FIG. 9 illustrates the procedures of the process performed in step S17 illustrated in FIG. 8 in more detail.

In an initial state of FIG. 9, the special word included in the record may be stored in the extraction candidate list (step S31). A description will hereinafter given of a particular example. A description will be given of the procedures of the process for a case in which three (3) special words “HTTP”, “WWW”, and “HTTP” appear in this order in the record, that is, these special words are listed in the extraction candidate list.

First, the word that is a candidate to be extracted, that is, an extraction target candidate, may be specified. In a case in which the words included in the extraction candidate list are rearranged in the ascending order of the word names (“HTTP”, “HTTP”, and “WWW”), the first word (the first “HTTP”) may be specified as the first extraction target candidate (step S32). The method of specifying the word that is the extraction target candidate from the extraction candidate list is not limited to the method using the word names in the ascending order, and any suitable method that does not select the same word that is once specified as the extraction target from the extraction target list a plurality of times, such as a method using the word names in the descending order.

Next, the first word (the first “HTTP”) in the ascending order and the frequency of use, “1”, of this first word may be stored in the temporary storage region such as the RAM 103 or the like (step S33). In a case in which the words included in the extraction candidate list are rearranged in the ascending order of the word names (“HTTP”, “HTTP”, and “WWW”), a judgement may be made to determine whether a next word exists (step S34). In this case, the next word (the second “HTTP”) exists in the extraction candidate list (YES in step S34), and in a case in which the words included in the extraction candidate list are rearranged in the ascending order of the word names (“HTTP”, “HTTP”, and “WWW”), this next word (the second “HTTP”) may be specified as the next extraction target candidate (step S35). Then, a judgement may be made to determine whether the same word as the extraction target candidate is stored in the temporary storage region (step S36). In this example, the first “HTTP” stored in step S33 and the second “HTTP” stored in step S35 are the same word (YES in step S36). Hence, in this case, the frequency of use of the word “HTTP” stored in the temporary storage region is incremented by “1” to “2”, and the incremented frequency of use, “2”, may be stored (step S37).

Next, the process of step S34 is executed again. In the ascending order of the extraction candidate list (“HTTP”, “HTTP”, and “WWW”), a word (“WWW”) next to the second “HTTP” exists (YES in step S34), and thus, the process of step S35 is executed in a manner similar to that described above. In this case, the same word as the extraction candidate word “WWW” is not stored in the temporary storage region (NO in step S36). Hence, the extraction candidate word (“WWW”) and the frequency of use, “1”, of this extraction candidate word are stored in the temporary storage region (step S38).

Next, the process of step S34 is executed again. In the ascending order of the extraction candidate list (“HTTP”, “HTTP”, and “WWW”), a word next to the word “WWW” does not exist (NO in step S34). In this example, the reference for the frequency of use of the special word to be extracted from the record may be set to “2” or greater, for example. According to this example, the frequency of use of the words stored in the temporary storage region is “2” for “HTTP” and “1” for “WWW”. For this reason, in this example, the word “HTTP” having the frequency of use, “2”, which is “2” or greater, may be extracted as the special word (step S39).

As described above, by setting the reference for the frequency of use of the word at the time of extracting the special word, it may be possible to reduce the possibility of registering a word, that includes an error and is erroneously written in the record, in the special word dictionary.

[Process (B) to Search Unregistered Word within Record Being Created]

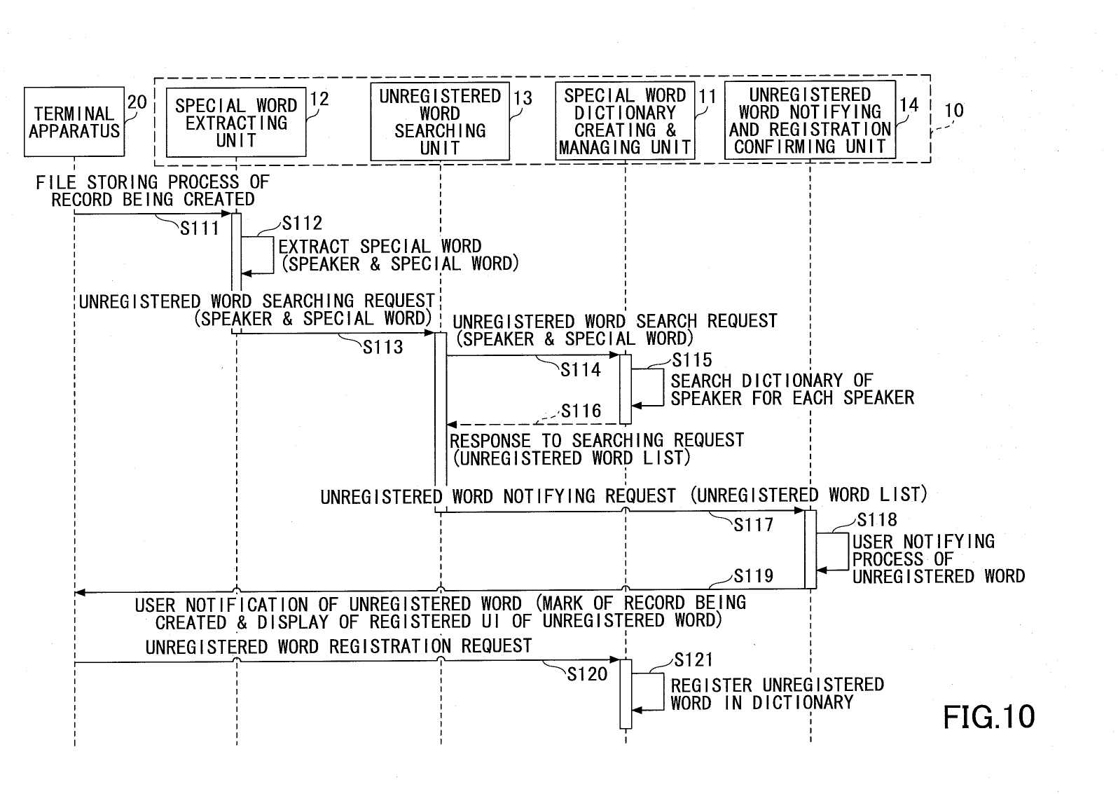

FIG. 10 is a diagram illustrating an example of procedures of a search operation to search unregistered words from the record that is being created in one embodiment of the present invention. A description will be given of a case in which the record creator who is the user of the terminal apparatus 20 performs a search in the special word dictionary, in order to confirm whether the special words included in the record that is being created contain errors and the like. In this embodiment, the words may be extracted for each comment made by the speaker during the conference, and a search may be made to determine whether the extracted words are registered in the special word dictionary of each speaker.

In step S111, the user (or record creator) of the terminal apparatus 20 may operate the keyboard, mouse, or the like in the operation part 208 of the terminal apparatus 20, and store the record that is being created. A storage destination may be specified by an address of a folder for storing the record that is being created, within the creating record storage part 121 of the record creating support apparatus 10. In response to a process to store the record that is being created, the record creating support apparatus 10 may perform an unregistered word searching process to execute a search in the special word dictionary in order to determine whether the word within the record that is being created is registered in the special word dictionary.

In step S112, when the process to store the record that is being created is executed in the creating record storage part 121, the special word extracting unit 12 of the record creating support apparatus 10 may execute a special word extracting process to extract the special word within the stored record. The special word extracting process to extract the special word within the record that is being created may be similar to the processes of steps S14 through S16 illustrated in FIG. 8 that extracts the special word from the past record. More particularly, all of the words may be extracted from the record that is being created and is set as the word extracting target. Then, a judgement may determine whether the extracted word is a special word. This judgement to determine whether the extracted word is a special word may be performed by judging whether the extracted word is included in the general dictionary stored in the general dictionary storage part 124. In other words, in a case in which the extracted word is not included in the general dictionary, this extracted word may be regarded as being a special word. In the case in which the extracted word is the special word, a special word list formed by the special words may be created and stored in the temporary storage region such as the RAM 203 or the like. On the other hand, in a case in which the extracted word is included in the general dictionary, this extracted word may be regarded as being a generally used word, and the special word extracting process is not executed with respect to the generally used word.

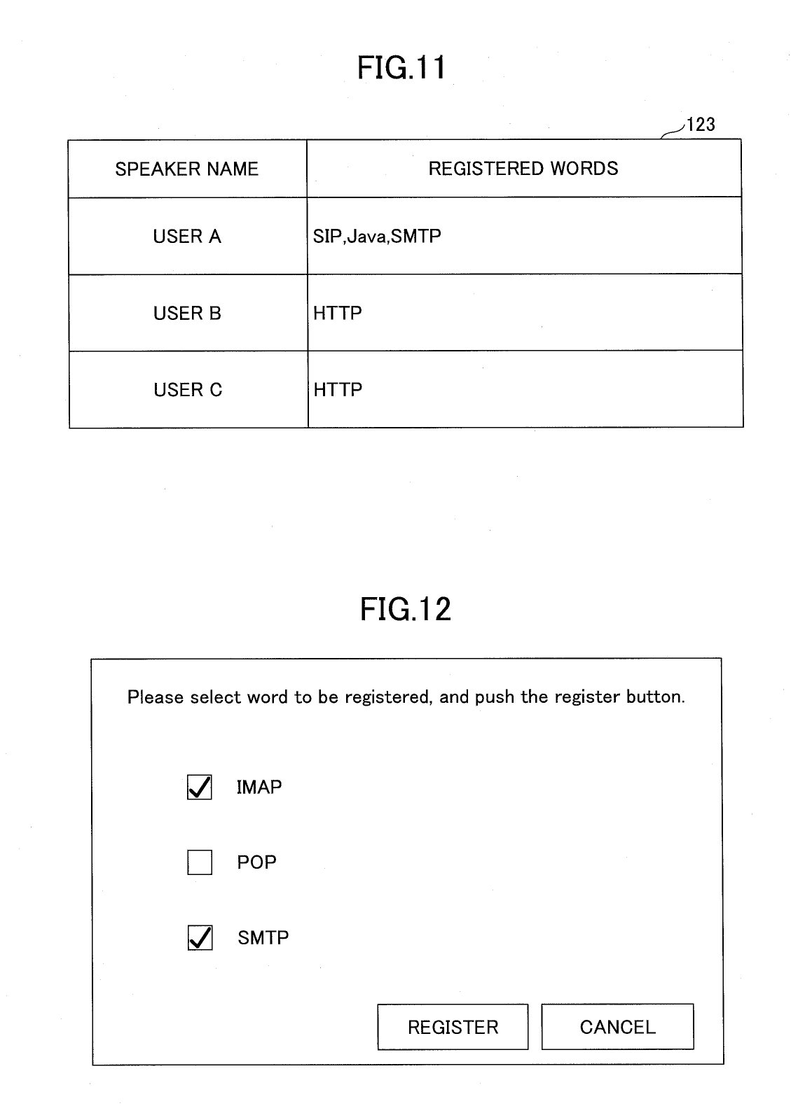

In addition, in this embodiment, the speaker written in the record that is being created and words included in the contents of speech by this speaker are made to correspond to each other during the special word extracting process. FIG. 11 is a diagram illustrating an example of a structure of special words extracted for each speaker from the record that is being created in one embodiment of the present invention. More particularly, FIG. 11 illustrates the special word list indicating the correspondence between the users A, B, and C written in the record that is being created, and the special words included in the speeches made by each of the users A, B, and C.

In step S113, when the special word extraction process with respect to the record that is being created ends, the special word extracting unit 12 may notify the unregistered word searching unit 13 of the unregistered word searching request. The unregistered word searching request may specify the memory address of the temporary storage region in which the special word list is stored.

In step S114, when the unregistered word searching unit 13 accepts the unregistered word searching request, the unregistered word searching unit 13 may request execution of the unregistered word searching process to the special word dictionary creating and managing unit 11.

In step S115, when the special word dictionary creating and managing unit 11 accepts the request to execute the unregistered word searching process from the unregistered word searching unit 13, the special word dictionary creating and managing unit 11 may refer to the memory address specified by the unregistered word searching request and acquire the special word for each speaker. As illustrated in FIG. 11, for example, the record that is being executed may include the users A, B, and C as the speakers, and the special words spoken by each of the users A, B, and C. The special words spoken by the user A are “SIP”, “Java”, and “SMTP”, the special word spoken by the user B is “HTTP”, and the special words spoken by the user C are “IMAP” and “POP” in FIG. 11. In this case, the special word dictionary creating and managing unit 11 may execute a search in the special word dictionary, corresponding to the user A and stored in the special word dictionary, and determine whether the words “SIP”, “Java”, and “SMTP” are registered in this special word dictionary corresponding to the user A. For example, if the words “SIP” and “Java” are registered in the special word dictionary of the user A but the word “SMTP” is not registered in the special word dictionary of the user A, the word “SMTP” may be stored in the unregistered word list. The unregistered word list may be stored in the temporary storage region such as the RAM 203 or the like. The special word dictionaries corresponding to the users B and C are searched in a manner similar to the special word dictionary corresponding to the user A, in order to determine whether the special words of the users B and C are registered in the special word dictionaries of the users B and C, respectively. In this example, the words “SMTP”, “IMAP”, and “POP” are stored in the unregistered word list. For example, a character string search using a known SQL (Structured Query Language) structure may be employed as the method of searching whether the special word appearing in the record that is being created is registered (or exists) in the special word dictionary. The search method may be any suitable match detection method that is generally employed.

In step S116, when the unregistered word searching process ends, the special word dictionary creating and managing unit 11 may notify the unregistered word searching unit 13 of the response to the unregistered word searching request (or unregistered word searching request response) in which the memory address where the unregistered word list is stored is specified.

In step S117, when the unregistered word searching unit 13 accepts the unregistered word searching request response, the unregistered word searching unit 13 may notify the unregistered word notifying and registration confirming unit 14 of the unregistered word notifying request to notify the unregistered word to the record creator. The unregistered word notifying request may specify the memory address where the unregistered word list is stored.

In step S118, when the unregistered word notifying and registration confirming unit 14 accepts the unregistered word notifying request, the unregistered word notifying and registration confirming unit 14 may execute a file editing on the record that is being created and underline a character string of the special word that is not registered, based on the special words stored in the unregistered word list. The unregistered word may be notified by any suitable method that facilitates the record creator to visually recognize the unregistered word, such as coloring the unregistered word, adding a marker to the unregistered word, and the like. In addition, the unregistered word notifying and registration confirming unit 14 may generate a user interface screen for registering unregistered special words to the special word dictionary. FIG. 12 is a diagram illustrating an example of the user interface screen to select an unregistered special word to be registered in one embodiment of the present invention. In this example, the unregistered special words “SMTP”, “IMAP”, and “POP” are displayed on the user interface screen. As illustrated in FIG. 12, the user interface screen may include the unregistered special words, check boxes for selecting the unregistered special words as the special words to be registered, a register button (or soft key) to be pushed in order to execute the registration of the selected unregistered special words.

In step S119, the display part 207 of the terminal apparatus 20 may display the record that is being created, in which the unregistered special words are underlined, and a registration selection screen to select the unregistered words illustrated in FIG. 12, for example.

In step S120, when the record creator selects the special word to be registered in the special word dictionary, from the registration selection screen to select the unregistered words, the terminal apparatus 20 may send an unregistered word registration request to the record creating support apparatus 10.

In step S121, when the special word dictionary creating and managing unit 11 accepts the unregistered word registration request, the special word dictionary creating and managing unit 11 may add the selected, unregistered special word to the special word dictionary of the speaker and the record creator stored in the special word dictionary storage part 123.

According to the process described above, the record creating support system 1 may automatically notify the record creator of the technical terms, abbreviations, and the like that are not contained in the general dictionary or the like, while creating the record. For this reason, the record creator may immediately confirm the existence of an error in the record, and immediately correct the record if the error exists. Hence, by utilizing the record creating support system 1, the record creator may confirm the accuracy of the technical terms, abbreviations, and the like in order to determine whether the words are correct, and efficiently create the record.

[First Modification]

In a first modification of one embodiment of the present invention, a plurality of types of special word dictionaries may be created, and the plurality of types of special word dictionaries may be utilized when searching unregistered words.

[Types and Structure of Special Word Dictionaries Created]

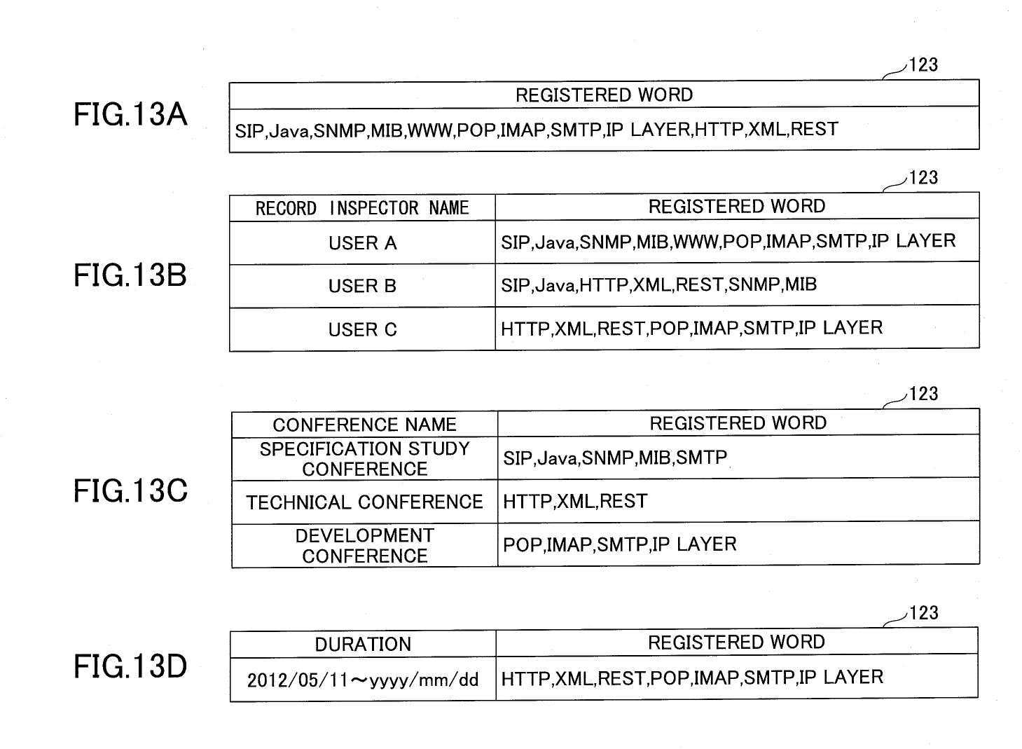

FIGS. 13A, 13B, 13C, and 13D are diagrams illustrating examples of structures of information in the special word dictionary storage part in one embodiment of the present invention. It is assumed for the sake of convenience that the past record, that is the special word extraction target for creating the special word dictionary, has the structure illustrated in FIG. 5.

FIG. 13A illustrates an example of the structure of the special word dictionary for a case in which the special words included in all of the record files illustrated in FIG. 5 are extracted.

FIG. 13B illustrates an example of the structure of the special word dictionary for a case in which the special words included in the inspected record file are extracted for each record inspector illustrated in FIG. 5.

FIG. 13C illustrates an example of the structure of the special word dictionary for a case in which the special word dictionary included in the record file corresponding to each of the conference names is extracted for each of the conference names illustrated in FIG. 5. Amongst different types of conferences, such as a conference related to management or the like and a conference related to technology and development or the like, the same word may have different meanings, usages, and contents. Hence, by creating the special word dictionary for each conference type, the usages of the words are taken into consideration, and a search conforming to the intentions of the record creator may be performed.

FIG. 13D illustrates an example of the structure of the special word dictionary for a case in which the special word dictionary included in the record within a target duration is extracted, by specifying the target duration based on the creation date and time of the record illustrated in FIG. 5.

According to this modification, the record creator may use the special word dictionary that is created for each usage. In addition, this modification may create the special word dictionary for each participant illustrated in FIG. 6 and the special word dictionaries illustrated in FIGS. 13A through 13D, and store all of the special word dictionaries in the special word dictionary storage part 123. However, in a case in which the storage capacity of the HD 104a or the memory is relatively small, for example, only specific special word dictionaries may be created and stored to suit the needs.

[Creating Dictionary Selection UI]

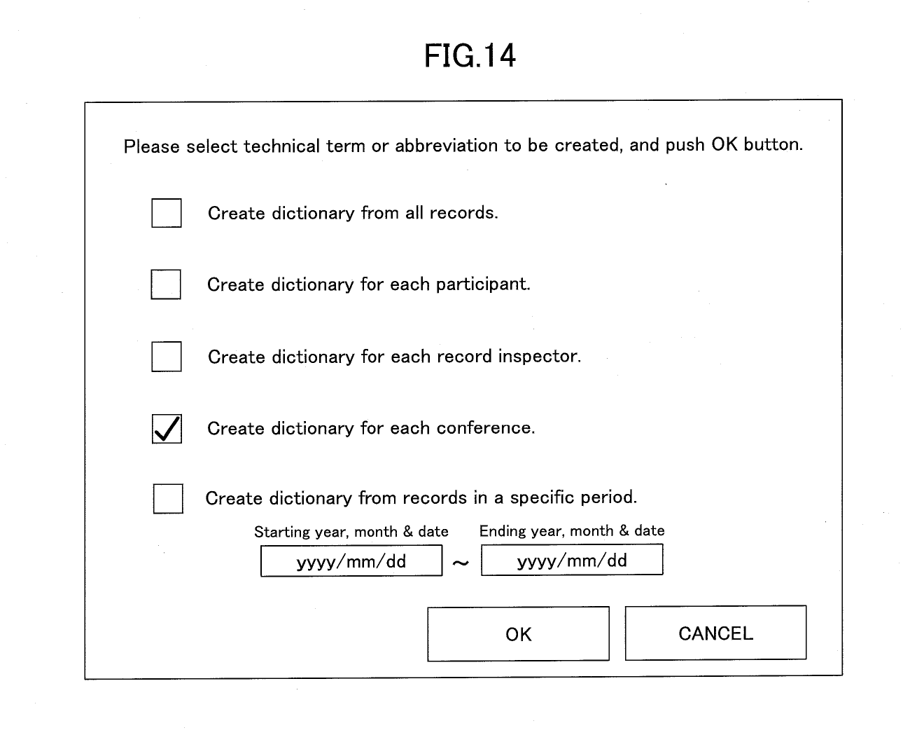

FIG. 14 is a diagram illustrating an example of the UI (User Interface) screen to select a dictionary to be created in a first modification of one embodiment of the present invention. The special word dictionary storage part 123 may store a plurality of special word dictionaries. However, only a specific special word dictionary may be created when it is desirable to shorten the processing time required to create the special word dictionary, for example. The screen illustrated in FIG. 14 may be displayed on the display part 107 of the record creating support apparatus 10 or the display part 207 of the terminal apparatus 20. In addition, the screen illustrated in FIG. 14 may be operated mainly by a manger who manages the record creating support system 1. The selected special word dictionary may be created by selecting a check box corresponding to the special word dictionary to be created and pushing an OK button on the screen illustrated in FIG. 14.

[Using Dictionary Selection UI]

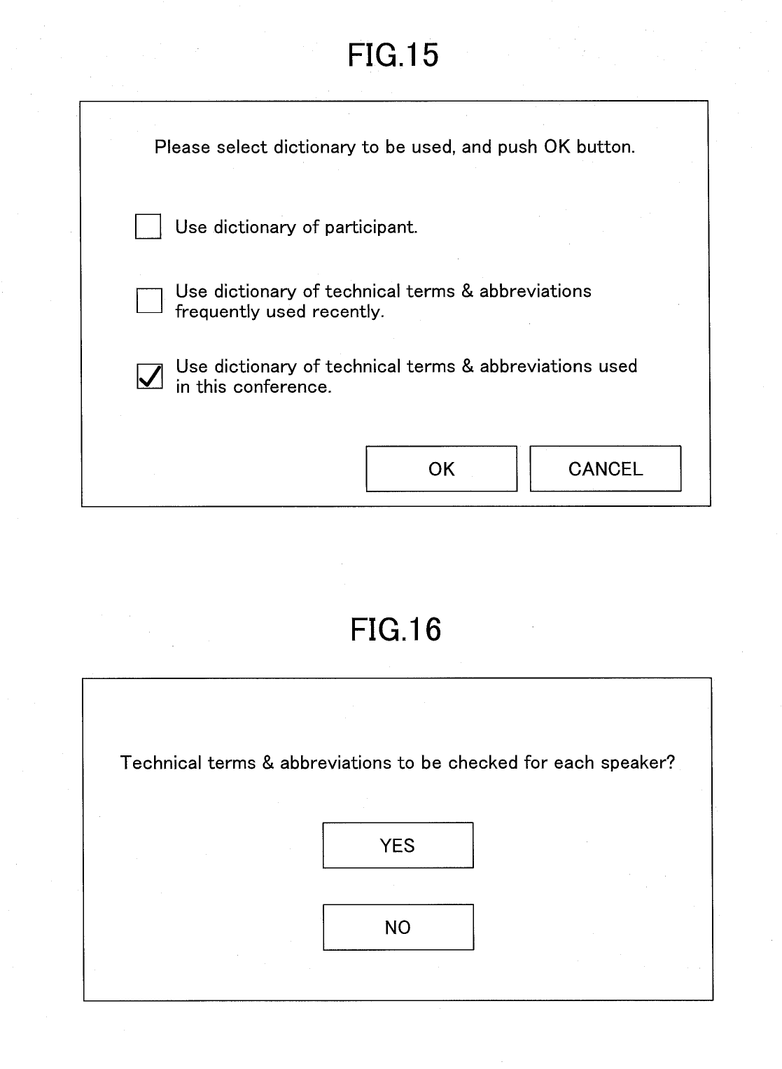

FIG. 15 is a diagram illustrating an example of the UI screen to select the dictionary to be used in the first modification of one embodiment of the present invention. As illustrated in FIG. 15, special word dictionaries to be used and check boxes corresponding to the special word dictionaries are displayed on the UI screen. In FIG. 15, “dictionary of technical terms & abbreviations frequently used recently” may refer to a dictionary that is frequently used recently in a preset time period, and the preset time period may be the past one (1) year from the present, for example. The preset time period may be set arbitrarily. When the record creator selects the check box on the screen illustrated in FIG. 15, the special word dictionary corresponding to the checked check box may be selected and used for the search to determine the unregistered special words.

[Selection UI to Select Use or Non-Use of Sender Information]

FIG. 16 is a diagram illustrating an example of the UI screen to select use or non-use of speaker information in the first modification of one embodiment of the present invention. More particularly, FIG. 16 illustrates the UI screen to select whether the special word dictionary is to be searched based on the special word for each speaker written in the record, when performing the search to determine whether the special word in the record that is being created by the record creator is an unregistered word. When a search is to be performed to determine whether the special word is registered in the special word dictionary for each speaker, a YES button illustrated in FIG. 16 may be pushed.

[General Operation of Unregistered Word Search]

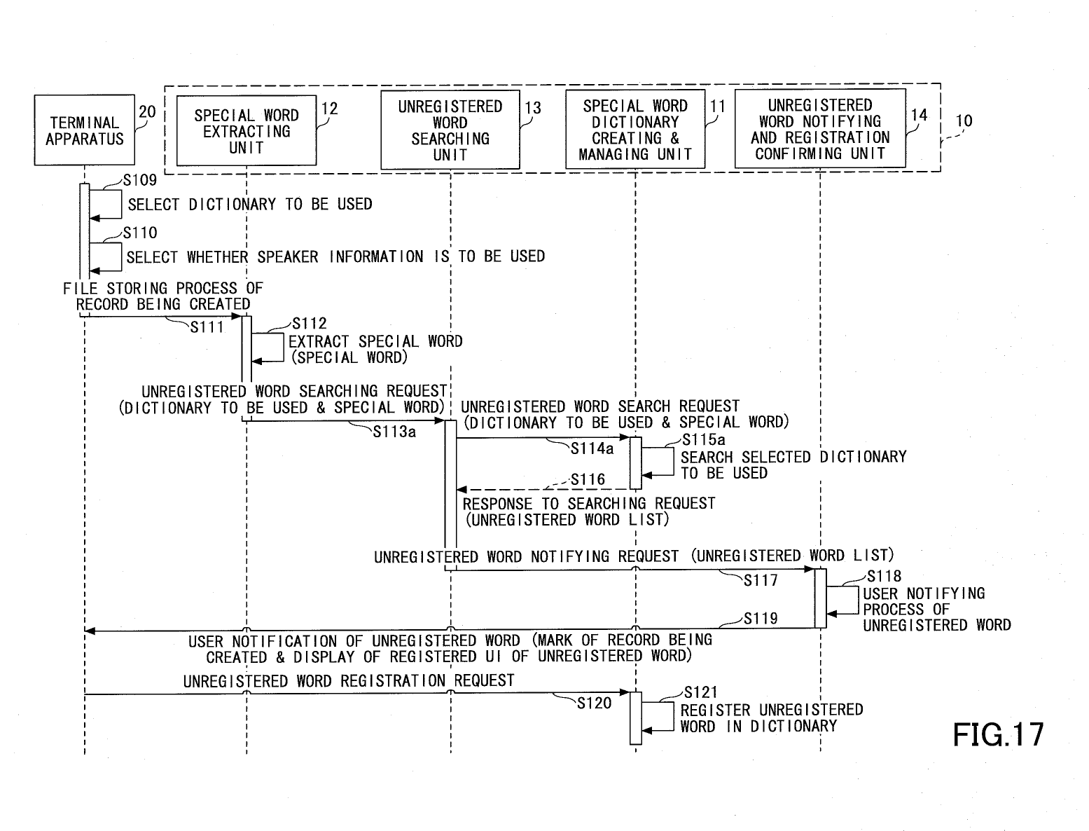

FIG. 17 is a diagram illustrating an example of procedures of the search operation to search unregistered words from the record that is being created in the first modification of one embodiment of the present invention. Similarly to the search operation illustrated in FIG. 10, a description will be given of a case in which the record creator who is the user of the terminal apparatus 20 performs a search in the special word dictionary, in order to confirm whether the special words included in the record that is being created contain errors and the like. In FIG. 17, those steps that are the same as those corresponding steps in FIG. 10 are designated by the same reference numerals, and a description thereof will be omitted.

In step S109, the record creator may select, on the terminal apparatus 20, the special word dictionary to be used in order to confirm whether the special word included in the record that is being created is registered in the special word dictionary. The special word dictionary may be selected from the screen illustrated in FIG. 15, for example. Information of the selected special word dictionary may be temporarily stored in the memory, such as the RAM 203, of the terminal apparatus 20.

In step S110, the record creator may select, on the terminal apparatus 20, whether the special word is to be extracted for each speaker written in the record that is being created, and whether the search is to be executed on the special word dictionary based on the speaker information. The use or non-use of the speaker information may be selected from the screen illustrated in FIG. 16, for example. Results of these selections may be temporarily stored in the memory, such as the RAM 203, of the terminal apparatus 20.

Processes of steps S111 and S112 may be the same as those illustrated in FIG. 10.

In step S113a, the special word extracting unit 12 of the record creating support apparatus 10 may notify the unregistered word searching unit 13 of the memory address where the information of the special word dictionary to be used, selected in step S109, and the special word included in the record that is being created, are stored. When the use of the speaker information is selected in step S110, the unregistered word searching unit 13 may be notified of the special word made to correspond to the speaker identified by the speaker information.

In step S114a, the unregistered word searching unit 13 may notify the special word dictionary creating and managing unit 11 of the unregistered word searching request in which the special word dictionary to be used and the special word are specified.

In step S115a, when the special word dictionary creating and managing unit accepts the request to execute the unregistered word searching process from the unregistered word searching unit 13, the special word dictionary creating and managing unit 11 may execute a search in the selected, special word dictionary to be used, in order to determine whether the special word included in the record that is being created is registered in the selected, special word dictionary to be used.

Processes of steps S116 through S121 may be the same as those illustrated in FIG. 10.

As described above, according to the first modification of one embodiment of the present invention, a plurality of types of special word dictionaries may be creased, and the special word dictionary to be used to confirm whether the special word is registered therein may be selected from the plurality of types of special word dictionaries. Hence, a search method to be used to search for unregistered words may be flexibly selected to suit the object, needs and the like of the record creator.

[Second Modification]

In a second modification of one embodiment of the present invention, when extracting the special word from the past record at the time of creating the special word dictionary, the special word extracting process may extract the special word included in the record without taking into consideration the frequency of use of the special word in the record.

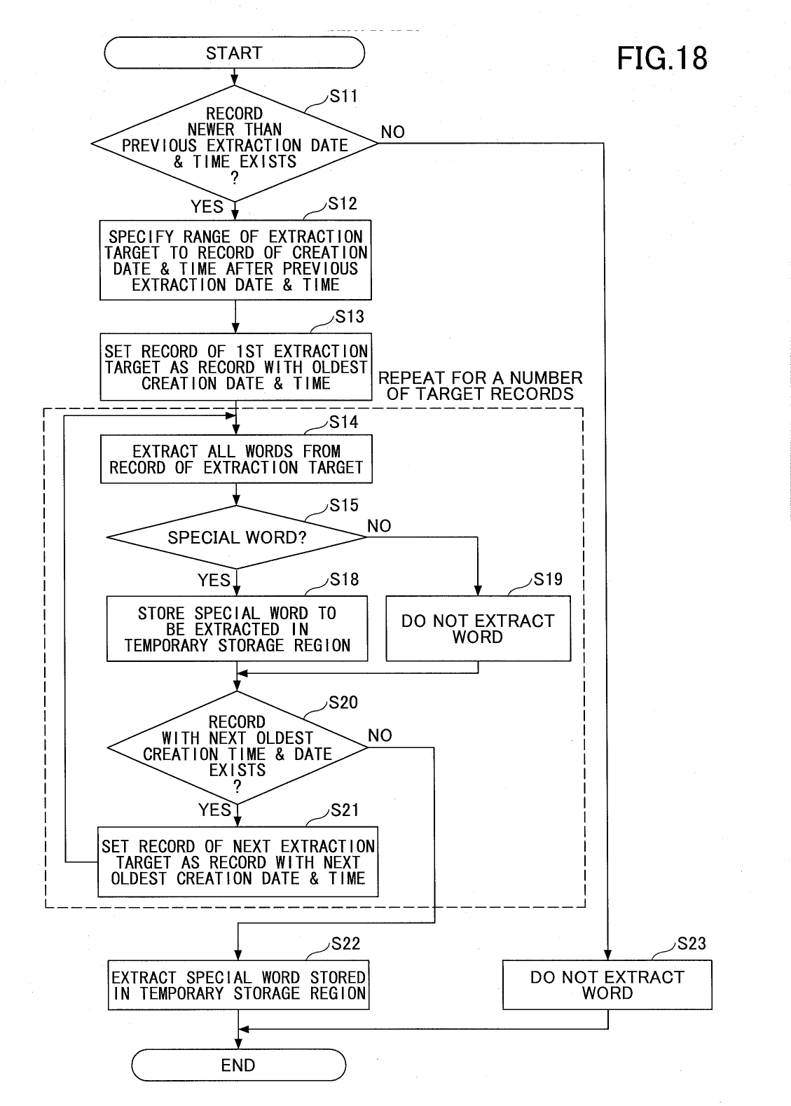

FIG. 18 is a flow chart for explaining an example of procedures of the special word extracting process in the second modification of one embodiment of the present invention. In FIG. 18, the processes of steps S16 and S17 illustrated in FIG. 8 are not performed. Otherwise, the processes of steps illustrated in FIG. 18 are the same as the process of those corresponding steps illustrated in FIG. 8, and a description thereof will be omitted.

In the second modification of one embodiment of the present invention, the frequency of use of the special word included in the past record is not taken into consideration when extracting the special word. For this reason, the load of the special word extracting process on the record creating support apparatus 10 may be reduced.

[Third Modification]

When creating the special word dictionary in the embodiment described above, the words included in the past record and not registered in the general dictionary are extracted as the special words. On the other hand, when creating the special word dictionary in a third modification of one embodiment of the present invention, the special word dictionary may be created based on all of the words written in the record, including the words registered in the general dictionary. In this case, when extracting the words included in the record that is being created, not only the special words, but also the words registered in the general dictionary, may be extracted, in order to enable confirmation of the general words and the like in addition to the confirmation of the special words.

In the embodiment described above, the record creating support system 1 is applied to the document file having the MS WORD (registered trademark) format, for example. However, the record creating support system 1 may be applied to an image file, for example. The image file may include files of bit map, JPEG (Joint Photographic Experts Group), JPEG2000, and the like.

According to the embodiment and modifications described above, a record creating support apparatus, a record creating support method, and a record creating support system may be provided, in which technical terms, abbreviations, and the like that are not listed in general English dictionaries, English-language dictionaries, and the like, may be notified to a creator of a record when the creator is creating the record, in order to enable the creator to immediately confirm whether an error exists in the record, and to correct the error if any.

The present invention can be implemented in any convenient form, for example, using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a WAP (Wireless Application Protocol) or 3G-compliant phone) and so on. Since the present invention can be implemented as software, each and every aspect of the present invention thus encompasses computer software implementable on a programmable device.

The computer software can be provided to the programmable device using any storage medium for storing processor readable code such as a floppy disk, a hard disk, a CD-ROM (Compact Disk-Read Only Memory), a magnetic tape device or a solid state memory device.

The hardware platform includes any desired hardware resources including, for example, a CPU, a RAM (Random Access Memory), and a HDD (Hard Disk Drive). The CPU may include processors of any desired type and number. The RAM may include any desired volatile or nonvolatile memory. The HDD may include any desired nonvolatile memory capable of recording a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

Although the modifications are numbered with, for example, “first,” “second,” or “third,” the ordinal numbers do not imply priorities of the modifications. Many other variations and modifications will be apparent to those skilled in the art.

Further, the present invention is not limited to these embodiments, but various variations and modifications may be made without departing from the scope of the present invention.

What is claimed is:

1. A record creating support apparatus to support creation of a record, comprising:
a storage unit configured to store a program; and
a processor configured to execute the program, wherein the processor includes
an extracting unit configured to extract a special word from a record that is being created;
a searching unit configured to search a special word dictionary in order to determine whether the special word extracted by the extracting unit is registered in the special word dictionary; and
a notifying unit configured to notify the special word when the searching unit determines that the special word is not registered in the special word dictionary.

2. The record creating support apparatus as claimed in claim 1, wherein the processor further comprises:
a creating unit configured to create the special word dictionary based on special words, included in a record that is created in past, and extracted by the extracting unit.

3. The record creating support apparatus as claimed in claim 2, wherein the extracting unit extracts the special word that appears at least a predetermined number of times in the record.

4. The record creating support apparatus as claimed in claim 2, wherein
the extracting unit extracts the special word included the record that includes identification information identifying a participant who participated in a conference corresponding to the record, and the special word included in the record of the conference to which the participant identified by the identification information participated, and
the creating unit creates the special word dictionary for each identification information of the participant extracted by the extracting unit.

5. The record creating support apparatus as claimed in claim 2, wherein
the extracting unit extracts identification information identifying an inspector of the record, and the special word included in the record inspected by the inspector identified by the identification information, and
the creating unit creates the special word dictionary for each identification information of the inspector extracted by the extracting unit.

6. The record creating support apparatus as claimed in claim 4, wherein
the extracting unit extracts the identification information of a speaker appearing in the record that is being created, and the special word spoken by the speaker identified by the identification information and included in the record that is being created, and
the searching unit searches the special word dictionary corresponding to the identification information of the speaker in order to determine whether the special word extracted by the extracting unit is registered in the special word dictionary corresponding to the identification information of the speaker.

7. The record creating support apparatus as claimed in claim 4, wherein the searching unit searches the special word dictionary corresponding to the identification information of each of participants who participated in a conference corresponding to the record that is being created.

8. The record creating support apparatus as claimed in claim 2, wherein
the extracting unit extracts a conference name of a conference corresponding to the record, and the special word registered in the record corresponding to the conference name, and
the creating unit creates, for each conference name, the special word dictionary registered with the special word in correspondence with the conference name extracted by the extracting unit.

9. The record creating support apparatus as claimed in claim 3, wherein the extracting unit extracts the special word included in the record that is created within a predetermined time.

10. The record creating support apparatus as claimed in claim 1, wherein the notifying unit notifies an unregistered special word, and inquires a creator of the record whether the unregistered special word is to be registered in the special word dictionary.

11. A record creating support method to support creation of a record by a computer, comprising:
extracting, by the computer, a special word from a record that is being created;
searching, by the computer, a special word dictionary in order to determine whether the special word extracted by the extracting is registered in the special word dictionary; and
notifying, by the computer, the special word when the searching determines that the special word is not registered in the special word dictionary.

12. The record creating support method as claimed in claim 11, further comprising:
creating, by the computer, the special word dictionary based on special words, included in a record that is created in past and stored in a storage unit, and extracted by the extracting.

13. The record creating support method as claimed in claim 12, wherein the extracting extracts the special word that appears at least a predetermined number of times in the record.

14. The record creating support method as claimed in claim 12, wherein
the extracting extracts the special word included the record that includes identification information identifying a participant who participated in a conference corresponding to the record, and the special word included in the record of the conference to which the participant identified by the identification information participated, and
the creating creates the special word dictionary for each identification information of the participant extracted by the extracting.

15. The record creating support method as claimed in claim 12, wherein
the extracting extracts identification information identifying an inspector of the record, and the special word included in the record inspected by the inspector identified by the identification information, and
the creating creates the special word dictionary for each identification information of the inspector extracted by the extracting.

16. The record creating support method as claimed in claim 14, wherein
the extracting extracts the identification information of a speaker appearing in the record that is being created, and the special word spoken by the speaker identified by the identification information and included in the record that is being created, and
the searching searches the special word dictionary corresponding to the identification information of the speaker in order to determine whether the special word extracted by the extracting is registered in the special word dictionary corresponding to the identification information of the speaker.

17. The record creating support method as claimed in claim 14, wherein the searching searches the special word dictionary corresponding to the identification information of each of participants who participated in a conference corresponding to the record that is being created.

18. The record creating support method as claimed in claim 12, wherein
the extracting extracts a conference name of a conference corresponding to the record, and the special word registered in the record corresponding to the conference name, and
the creating creates, for each conference name, the special word dictionary registered with the special word in correspondence with the conference name extracted by the extracting.

19. The record creating support method as claimed in claim 13, wherein the extracting extracts the special word included in the record that is created within a predetermined time.

20. The record creating support method as claimed in claim 11, wherein the notifying notifies an unregistered special word, and inquires a creator of the record whether the unregistered special word is to be registered in the special word dictionary.
